(19) United States
(12) Patent Application Publication
(10) Pub. No.: US 2015/0262726 A1
(43) Pub. Date: Sep. 17, 2015

(54) GRAPHENE CONDUCTING WIRE AND METHOD OF MAKING THE SAME

(71) Applicant: MERRY ELECTRONICS (SUZHOU) CO., LTD., SUZHOU CITY (CN)

(72) Inventors: Mou-Tan LEE, Taichung City (TW); Tse-Yu LIU, Taichung City (TW)

(73) Assignee: MERRY ELECTRONICS (SUZHOU) CO., LTD., SUZHOU CITY (CN)

(21) Appl. No.: 14/206,565

(22) Filed: Mar. 12, 2014

(51) Int. Cl. H01B 1/04; H01B 13/06; H01B 13/00; H01B 1/02; H01B 17/00

(52) U.S. Cl. CPC H01B 1/04; H01B 1/026; H01B 17/00; H01B 13/0016; H01B 13/002; H01B 13/06

(57) ABSTRACT

A graphene conducting wire and a method of making the same are disclosed. The graphene conducting wire includes a wire core made of graphene and a copper layer encapsulating around an outer circumference of the wire core. The graphene conducting wire has an enhanced conductibility, reduced weight and improved flexibility without adverse influence on the welding characteristic thereof. By depositing graphene on a copper foil and then rolling the copper foil into the conducting wire, the technical problem that the graphene can hardly be processed into wire core is solved.

### BACKGROUND OF THE INVENTION

1. Field of the Invention

The present invention relates generally to conducting wires and more particularly, to a graphene conducting wire and a method of making the same.

2. Description of the Related Art

Copper wires, alloy wires and copper-clad aluminum wires are often used as conducting wires. However, these wires have many disadvantages including high resistance, heavy weight, high frangibility and are easy to break, poor performance of high temperature and aging resistance.

### SUMMARY OF THE INVENTION

The present invention has been accomplished under the circumstances in view. It is an objective of the present invention to provide a graphene conducting wire having enhanced conductibility, lightweight, improved flexibility, and a method of making the same.

To attain the above-mentioned objective, the technical solution adopted by the present invention is to provide a graphene conducting wire comprising a wire core made of graphene and a copper layer encapsulating around an outer circumference of the wire core.

Preferably, the graphene conducting wire may further comprise an insulated layer surrounding around the copper layer.

More preferably, a self-adhesive layer may be arranged on an outer circumference of the insulated layer.

The method of making the above-mentioned graphene conducting wire comprises the steps of:

a) depositing a graphene layer on a surface of a copper foil by chemical vapor deposition;

b) rolling the copper foil of step a) into a conducting wire in a way that the graphene layer is configured inside the conducting wire;

c) applying insulated paint on the conducting wire and baking the conducting wire that is applied with the insulated and self-adhesive paint; and

d) cooling and then receiving the conducting wire.

Preferably, the copper foil may have a thickness more than or equal to 0.001 mm and less than or equal to 10 mm.

By means of the above-mentioned technical solution, the present invention has the following advantages compared to the prior art.

1. Because the graphene is constructed inside the copper layer, the conductibility of the conducting wire can be enhanced, the weight of the conducting wire can be reduced and the flexibility of the conducting wire can be improved under the condition of not having adverse influence on welding characteristic of the conducting wire.

2. Because the present invention adopts the method of depositing graphene on a copper foil and then rolling the copper foil into the conducting wire, the technical problem that the graphene can hardly be processed into wire core is solved.

### BRIEF DESCRIPTION OF THE DRAWINGS

FIG. 1 is a schematic cross-sectional view of the graphene conducting wire of the present invention.

### DETAILED DESCRIPTION OF EMBODIMENTS

The present invention will become more fully understood from the detailed description given herein below and the accompanying drawing showing an embodiment of the present invention.

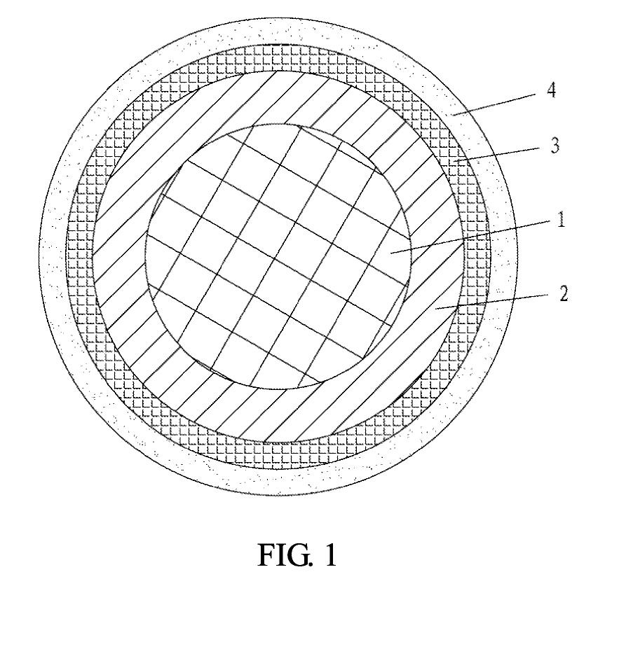

FIG. 1 schematically shows an embodiment of the present invention. As shown in FIG. 1, a graphene conducting wire comprising a wire core 1 made of graphene and a copper layer 2 encapsulating around an outer circumference of the wire core 1 is provided. An insulated layer 3 surroundingly coated on an outer circumference of the copper layer 2 is further provided in this embodiment of the present invention. The graphene conducting wire further comprises a self-adhesive layer 4 surroundingly arranged on an outer circumference of the insulated layer 3.

The method of making the graphene conducting wire comprises the following steps.

a) Deposit a graphene layer on a surface of a copper foil having a thickness of 0.01 mm by chemical vapor deposition.

b) Roll the copper foil of step a) into a conducting wire in a way that the surface deposited with the graphene layer is rolled inward, such that the graphene layer is constructed inside the conducting wire.

c) Apply insulated paint on the lead wire and then dry the insulated paint coated on the lead wire by baking. Repeatedly perform the aforesaid step for several times so as to form an insulated layer on the outer circumference of the conducting wire. Thereafter, a self-adhesive material is applied on the conducting wire thus obtained to form a self-adhesive layer.

d) Cool and then receive the conducting wire.

Because the present invention adopts the method of depositing graphene on a copper foil and then rolling the copper foil into the conducting wire, the technical problem that the graphene can hardly be processed into wire core is solved. Because the graphene is constructed inside the copper layer 2, the conductibility of the conducting wire can be enhanced, the weight of the conducting wire can be reduced and the flexibility of the conducting wire can be improved under the condition of not having adverse influence on welding characteristic of the conducting wire.

It should be understood that the detailed description and specific example, while indicating preferred embodiment of the invention, are given by way of illustration only, and thus are not limitative of the present invention. The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A graphene conducting wire comprising a wire core made of graphene and a copper layer encapsulating around an outer circumference of the wire core.

2. The graphene conducting wire as claimed in claim 1, further comprising an insulated layer arranged on an outer circumference of the copper layer.

3. The graphene conducting wire as claimed in claim 2, further comprising a self-adhesive layer arranged on an outer circumference of the insulated layer.

4. A method of making the graphene conducting wire of claim 1, comprising the steps of:
a) depositing a graphene layer on a surface of a copper foil by chemical vapor deposition;
b) rolling the copper foil of step a) into a conducting wire in a way that the graphene layer is configured inside the conducting wire;
c) applying insulated paint on the conducting wire and baking the conducting wire that is applied with the insulated paint; and
d) cooling and then receiving the conducting wire.

5. The method as claimed in claim 4, wherein the copper foil has a thickness more than or equal to 0.001 mm and less than or equal to 10 mm.

6. The method as claimed in claim 4, wherein after the insulated paint is cured to form an insulated layer on the conducting wire in step c), a step of applying self-adhesive material on the insulated layer to form a self-adhesive layer is carried out before the step d).
